(19) United States
(12) Patent Application Publication
(10) Pub. No.: US 2022/0021830 A1
(43) Pub. Date: Jan. 20, 2022

(54) OPTICAL SENSING DEVICE AND METHOD THEREOF

(71) Applicant: Novatek Microelectronics Corp., Hsinchu (TW)

(72) Inventors: Kuo Wei Cheng, Hsinchu City (TW); Jen-Yi Lin, Hsinchu City (TW); Jung-Chen Chung, Hsinchu County (TW)

(73) Assignee: Novatek Microelectronics Corp., Hsinchu (TW)

(21) Appl. No.: 16/933,941

(22) Filed: Jul. 20, 2020

(51) Int. Cl. H04N 5/369; H04N 5/378

(52) U.S. Cl. CPC H04N 5/3698; H04N 5/378

(57) ABSTRACT

An optical sensing device, including a first power rail, a second power rail, and a plurality of optical sensing elements arranged in an array, is provided. Each optical sensing element can include a photo diode, a reset switch, and a buffer. The reset switch can have a control terminal to receive a reset signal. A first terminal of the reset switch can be coupled to the first power rail and a second terminal of the reset switch is coupled to the photo diode. A first terminal of the buffer can be coupled to the second power rail, a second terminal of the buffer can be coupled to the second terminal of the reset switch and the photo diode, and a third terminal of the buffer is configured to provide a sensing signal. The second power rail is separate or independent from the first power rail.

### BACKGROUND

### Technical Field

The disclosure relates to an optical sensing device, and particularly relates to an optical sensing device providing two power rails.

### Description of Related Art

The optical sensing device includes a plurality of pixel units arranged in an array and a power rail, wherein the power rail enables a bias current to flow through the pixel units by providing an operating voltage. In short, current is loaded from the power rail via the trace. However, in practice, the current value of the load current needs a period of time (related to the time constant value (τ=RC)) to stabilize before becoming a preset current value of the bias current. Moreover, due to the instability of the load current, the IR drop of the trace is also unstable. The above factor will cause the actual operating voltage received by the pixel units to fluctuate according to the distribution positions of the pixel units and the operating voltage received by each pixel unit at different times is also different. This leads to the sensing accuracy of the optical sensing device to be reduced. Therefore, a demand for solutions to improving the sensing accuracy of the optical sensing device.

### SUMMARY

The disclosure provides an optical sensing device and a method thereof, which can improve the sensing accuracy of the optical sensing device.

An optical sensing device of the disclosure includes a first power rail, a second power rail, and a plurality of optical sensing elements arranged in an array. Each optical sensing element includes a photo diode, a reset switch, and a buffer. The reset switch has a control terminal configured to receive a reset signal. A first terminal of the reset switch is coupled to the first power rail and a second terminal of the reset switch is coupled to the photo diode. A first terminal of the buffer is coupled to the second power rail, a second terminal of the buffer is coupled to the second terminal of the reset switch and the photo diode, and a third terminal of the buffer is configured to provide a sensing signal. The second power rail is independent from the first power rail.

An optical sensing method of the disclosure is applicable to an optical sensing device, wherein the optical sensing device includes a plurality of optical sensing elements arranged in an optical sensing element array. Each optical sensing element includes a photo diode, a reset switch coupled to the photo diode, and a buffer coupled to the reset switch and the photo diode. The optical sensing method of the disclosure includes the following steps. The first power rail is provided to a first terminal of the reset switch. The second power rail independent from the first power rail is provided to a first terminal of the buffer. A reset signal is provided to control the reset switch according to the reset signal. A sensing signal is provided by the buffer.

An optical sensing device of the disclosure includes a first power rail, configured to provide a first voltage; a second power rail, configured to provide a reset voltage; and a plurality of optical sensing elements, arranged in an optical sensing element array, coupled to the first power rail and the second power rail to receive the first voltage and the reset voltage, and configured to be reset respectively according to the reset voltage in each of two sensing operations during a pixel read-out cycle. The reset voltage can be independent or separate from the first voltage provided by the first power rail such that a voltage level of the reset voltage is substantially the same during the two sensing operations of the pixel read-out cycle.

Based on the above, since the first power rail and the second power rail are independent from each other, the reset operation of the optical sensing element is not affected by the sensing operation, so that the operating voltage source of the reset operation is relatively stable. In this way, the signal difference component of the optical sensing element obtained through a correlated double sampling (CDS) mechanism is relatively pure, thereby improving the sensing accuracy of optical sensing.

To make the aforementioned and other features of the disclosure more comprehensible, several embodiments accompanied with drawings are described in detail as follows.

### BRIEF DESCRIPTION OF THE DRAWINGS

FIG. 1 is a circuit diagram of an optical sensing device according to an embodiment of the disclosure.

FIG. 2 is a signal timing diagram of an optical sensing device not using the disclosure.

FIG. 3 is a signal timing diagram of an optical sensing device using the disclosure.

FIG. 4 is a flowchart of an optical sensing method according to an embodiment of the disclosure.

### DETAILED DESCRIPTION OF DISCLOSED EMBODIMENTS

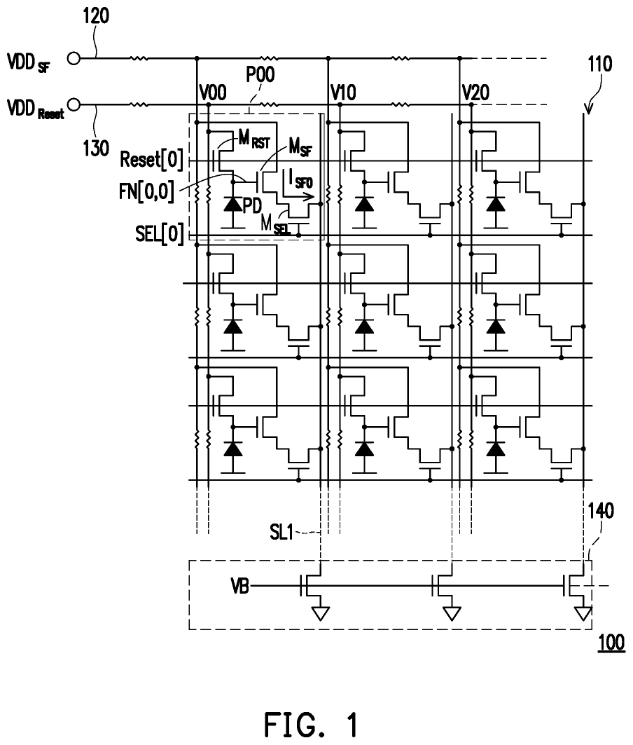

FIG. 1 is a circuit diagram of an optical sensing device according to an embodiment of the disclosure. Referring to FIG. 1, an optical sensing device 100 includes an optical sensing array 110, a power rail 120, a power rail 130, and a bias current generating circuit 140. The optical sensing array 110 includes a plurality of optical sensing elements. The optical sensing device may further comprise a reading out circuit (not shown) configured to reading a sensing signal from the optical sensing array 110.

The power rail 120 provides an operating voltage VDD_{SF} for each optical sensing element to form a bias current. The power rail 130 provides an operating voltage VDD_{Reset} for resetting the photo diode of each optical sensing element. The power rail 120 and the power rail 130 are independent from each other. The power rail 120 may be coupled to one power supply and the power rail 130 may be coupled to another power supply different from the aforementioned power supply. This means that the providing the operating voltage VDD_{SF} is independently performed from the providing the operating voltage VDD_{Reset}. In other words, the current or voltage level provided by the operating voltage VDD_{SF} is not affected by the operating voltage VDD_{Reset}.

The bias current generating circuit 140 is coupled to each optical sensing element via a plurality of sensing lines including the sensing line SL1 and is configured to generate the bias current of each optical sensing element (such as the bias current I_{SF0} of the optical sensing element P00) with a bias voltage VB.

Each of the optical sensing element may include a reset switch, a photo diode, a buffer, and a selection switch. In the embodiment, the optical sensing element may be a thin-film transistor (TFT) unit. The buffer may be implemented as a source follower. FIG. 1 also shows a detailed structure of the optical sensing element, such as the optical sensing element P00 according to an embodiment. However, the disclosure can be applied to different structures of optical sensing element. In the embodiment, a reset switch MRST in the optical sensing element P00 can be coupled between the power rail 130 and a node FN[0,0], and a first terminal of the reset switch MRST receives an operating voltage V00 from the power rail 130. A photo diode PD is coupled between the node FN[0,0] and a reference voltage such as a ground voltage, and is configured to sense light energy to be converted into electrical energy. A buffer M_{SF} is coupled between the power rail 120 and a selection switch M_{SEL}, and is controlled by the voltage of the node FN[0,0]. In more detail, one terminal of the buffer M_{SF} can be coupled to the power rail 130. Another terminal of the buffer M_{SF} can be coupled to the selection switch M_{SEL} to provide the sensing signal. A control terminal of the buffer M_{SF} can be coupled to the node FN[0,0]. In the sensing operation, the sensing result of the photo diode PD affects the voltage of the node FN[0,0], which is also the gate voltage of the buffer M_{SF}. The gate voltage of the buffer MSF then affects the conductivity level of the buffer M_{SF}, thereby changing a bias current I_{SF0} flowing through the buffer M_{SF}. The selection switch M_{SEL} is coupled between the buffer M_{SF} and a sensing line SL1, and is controlled by the voltage of a selection line SEL[0]. In more detail, the selection switch M_{SEL} can be controlled by a selection signal, and one terminal of the selection switch can be coupled to the a terminal of the buffer M_{SF} to provide the sensing signal from another terminal of the selection switch M_{SEL}. With the selection signal applied to the selection line SEL[0], the selection switch M_{SEL} can responsively conduct (also referred to as being turned on), so that the bias current I_{SF0} may flow out through the sensing line SL1 to perform the sensing operation.

In addition, FIG. 1 also illustrates an internal resistance of a trace (represented by the resistance symbol without reference numeral) to show the influence of the internal resistance on the IR drop of the trace. Due to the unstable IR drop of the trace and the influence of the RC effect of the circuit, the operating voltage V00′V10′V20, . . . received by each optical sensing element to reset the photo diode fluctuates with time and position. For example, the operating voltage V00 may be different from the operating voltage V10 and the operating voltage V20. Moreover, each of the operating voltage V00, the operating voltage V10 and the operating voltage V20 at different time points may also be different. As will explained more, one main factor affecting the sensing accuracy of the optical sensing device is whether the reset voltage (reset to the current operating voltage) of the same optical sensing element at different times is the same.

As will also explained more, since the voltage sources of the reset operation and the sensing operation are separate (i.e., the power rail 130 is independent from the power rail 120), the reset voltage sensed at different time points may be regarded as substantially the same. Consequently, a signal difference component ΔV_{sig} representing a sensing result is relatively accurate.

More specifically, since the power rail 130 to which the reset switch M_{RST} is coupled is arranged to be independent from the power rail 120, the operating voltages V00, V10, and V20 etc. applied to each reset switch M_{RST} may not be influenced by the IR drop caused by the load current flowing through the buffer MSF. That is to say the load current flowing through the power rail 120 is independent from the load current flowing through the power rail 130. This means that a reset operation is less affected by the sensing operation. Moreover, the influence of a time constant on the reset operation is also mitigated. The above factors cause the voltage of the node FN to approach quickly the operating voltage V00. Consequently, the reset voltage (charged to the operating voltage V00) sensed at different time points may be regarded as the same, enhancing accuracy of the signal difference component ΔV_{sig}.

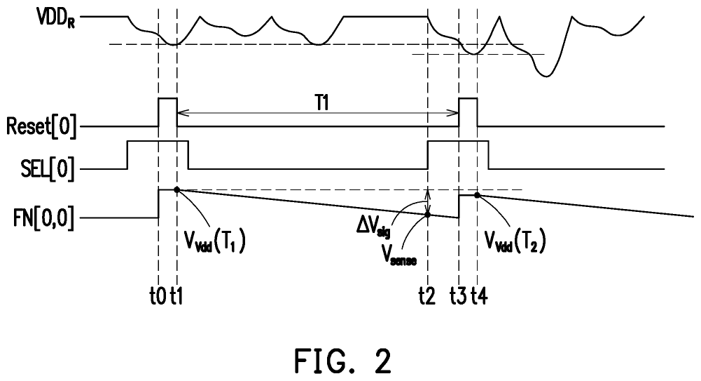

In the embodiment, the voltage level of the operating voltage VDD_{SF} provided by the power rail 120 is different from the voltage level of the operating voltage VDD_{Reset} provided by the power rail 130. However, in other embodiments, the voltage level of the operating voltage VDD_{SF} may also be the same as the voltage level of the operating voltage VDD_{Reset}. In an embodiment, the voltage values of the operating voltages VDD_{SF} and VDD_{Reset} may both be 5V. In another embodiment, the voltage values of the operating voltages VDD_{SF} and VDD_{Reset} may both be 3.3V. The focus of the above two embodiments is that for the reset operation and the sensing operation are from different operating voltage sources. Moreover, the power rail 120 and the power rail 130 do not necessarily need to be located at the same side of the optical sensing array 110 as shown in FIG. 2. In other embodiments, the power rail 120 and the power rail 130 may be located at opposite sides of the optical sensing array 110.

In the following, details are provided for the reason why the signal difference component ΔV_{sig} sensed is relatively accurate by utilizing two independent power rails 120 and 130. The optical sensing element is reset before sensing. At this time, the voltage value (equivalent to the voltage value of the node FN[0,0] in FIG. 1) of the optical sensing element is pulled up to the current operating voltage due to the reset operation and is recorded as V_{VDD}(T1). The optical sensing device may perform sensing according to the CDS mechanism, in which two sensing operations may be performed for each pixel read-out cycle. Specifically, the optical sensing device performs a first sensing of the voltage value (including the signal difference component ΔV_{sig} generated by the optical sensing element due to light sensitivity) of the optical sensing element when the integration time is almost ending. The voltage value sensed is recorded as V_{VDD}(T1)−ΔV_{sig}. Next, the optical sensing element is reset (pulled up to the current operating voltage) and a second sensing is performed. The voltage value sensed is recorded as V_{VDD}(T2). Finally, the pure signal difference component ΔV_{sig} may be obtained by subtracting the two sensing results (V_{VDD}(T2)−(V_{VDD}(T1)−ΔV_{sig}))

For the optical sensing element P00, the reset switch M_{RST} of the optical sensing element P00 is turned on by changing the voltage level of a reset line Reset[0] to pull up the voltage of the node FN[0,0] to the current operating voltage (recorded as V_{V00}(T1)). Next, the reset switch M_{RST} is turned off and the integration time begins. At this time, the node FN[0,0] is floating, the voltage of the node FN[0,0] gradually drops from a high point (operating voltage V_{V00}(T1)), and the degree of drop will be affected by the sensing result of the photo diode PD. The voltage of the node FN[0,0] is reflected on the source voltage of the buffer MS_{F}, thereby affecting the magnitude of the bias current I_{SF0}. At a time point when the integration time is almost ending, the optical sensing device 100 turns on the selection switch M_{SEL} by changing the voltage level of the selection line SEL[0], so that the bias current (reflecting the voltage value of the photo diode PD) flows into the sensing line SL1 to obtain a first sensing result. The first sensing result includes the signal difference component of the optical sensing element due to light sensitivity and is recorded as ΔV_{sig}.

Then, the optical sensing device 100 turns on the reset switch M_{RST} to reset the voltage of the photo diode PD again, so as to pull up the voltage of the node FN[0,0] to the current operating voltage (recorded as V_{V00}(T2)). The optical sensing device 100 also senses the bias current (reflecting the voltage value of the reset photo diode PD) to obtain a second sensing result. Finally, the pure signal difference component ΔV_{sig} is obtained by subtracting the two sensing results (V_{V00}(T2)−(V_{V00}(T1)−ΔV_{sig})).

Since the voltage sources of the reset operation and the sensing operation are separate (i.e., the power rail 130 is independent from the power rail 120), the reset voltage sensed at different time points may be regarded as substantially the same, so that the signal difference component ΔV_{sig} sensed is relatively accurate.

The difference between using the disclosure and not using the disclosure (prior art) will be explained below from the signal timing diagrams. FIG. 2 is a signal timing diagram of an optical sensing device not using the disclosure. Please refer to FIG. 2. The optical sensing device has only one power rail to provide an operating voltage VDD_{R} to each optical sensing element for a reset operation and a sensing operation. The operating voltage VDD_{R} fluctuates due to current loading and unstable IR drop on the trace.

As illustrated in paragraph [0020] of the present invention, the optical sensing element undergoes a reset before a sensing operation, then performs the first sensing to obtain the voltage value recorded as V_{VDD}(T1)−ΔV_{sig}, wherein ΔV_{sig} represents the voltage value change of the optical sensing element. A second sensing is performed after the optical sensing element is reset again, and the voltage value of the current operating voltage recorded as V_{VDD}(T2) is obtained. Finally, a signal Vcds(=V_{VDD}(T2)−(V_{VDD}(T1)−ΔV_{sig})) may be read through a correlated double sampling (CDS) mechanism. However, the disclosure is not limited to CDS mechanism.

Ideally, the values of the operating voltages V_{VDD}(T1) and V_{VDD}(T2) are the same or almost the same, so the pure ΔV_{sig} may be obtained through the CDS mechanism and the factor of the operating voltage being different due to the distribution position of the pixel unit may be neglected. However, in practice, the operating voltage fluctuates, so the values of the operating voltages V_{VDD}(T1) and V_{VDD}(T2) measured at different times have errors, which makes it impossible to obtain the pure ΔV_{sig} through the CDS mechanism. In other words, the sensing accuracy of the optical sensing device is reduced.

In details, before a time point t0, a selection switch of a corresponding optical sensing element is turned on through a selection line SEL[0]. Between the time point t0 and a time point t1, a reset switch of the optical sensing element is turned on through a reset switch Reset[0] to pull up the voltage of a node FN[0,0] to a high point (operating voltage V_{VDD}(T1)). Then, the reset switch is turned off and an integration time T1 begins. At a time point t2 when an integration time T1 is almost ending, a selection switch is turned on again for a first sensing.

At this time, a voltage value Vₛₑₙₛₑ of the node FN[0,0] is reflected on the bias current to be sensed. It can be seen from FIG. 2 that the voltage value Vₛₑₙₛₑ is equal to the difference value between the operating voltage V_{VDD}(T1) and a signal difference component ΔV_{sig}. In other words, a first sensing result includes the signal difference component ΔV_{sig} generated by the optical sensing element due to light sensitivity during the integration time T1. Between a time point t3 and a time point t4, the reset switch is turned on to charge the voltage of a photo diode to the current operating voltage V_{VDD}(T2). However, due to the fluctuation of the operating voltage VDD_{R}, the operating voltage V_{VDD}(T1) and the operating voltage V_{VDD}(T2) may have significant errors, resulting in the inability to obtain the pure change component ΔV_{sig} through the CDS mechanism.

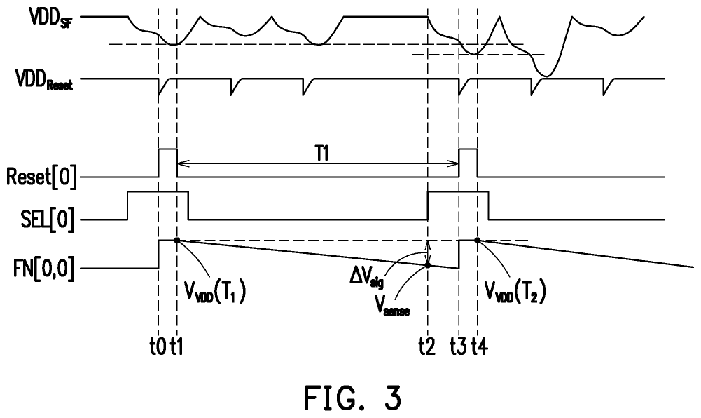

FIG. 3 is a signal timing diagram of an optical sensing device using the disclosure. Please refer to FIG. 1 and FIG. 3 at the same time. The optical sensing device 100 has two power rails 120 and 130 to respectively provide the operating voltage VDD_{SF} and the operating voltage VDD_{Reset} to each optical sensing element for the sensing operation and the reset operation. Since the voltage sources are separate, for the same optical sensing element, the reset voltage sensed at different time points may be regarded as the same. Before the time point t0, the selection switch MSEL of the corresponding optical sensing element P00 is turned on through the selection line SEL[0]. Between the time point t0 and the time point t1, the reset switch M_{RST} of the optical sensing element P00 is turned on through the reset line Reset[0] to pull up the voltage of the node FN[0,0] to the high point (operating voltage V_{V00}(T1)). Then, the reset switch M_{RST} is turned off and the integration time T1 begins. At the time point t2 when the integration time T1 is almost ending, the selection switch M_{SEL} is turned on again for the first sensing.

At this time, the voltage value Vₛₑₙₛₑ of the node FN[0,0] is reflected on the bias current I_{SF0} to be sensed. It can be seen from FIG. 3 that the voltage value Vₛₑₙₛₑ is equal to the difference value between the operating voltage V_{V00}(T1) and the signal difference component ΔV_{sig}. In other words, the first sensing result includes the signal difference component ΔV_{sig} of the optical sensing element P00 due to light sensitivity during the integration time T1. Between the time point t3 and the time point t4, the reset switch M_{RST} is turned on to charge the voltage of the photo diode PD to the current operating voltage V_{V00}(T2). However, due to the separation between the voltage sources, a voltage level received by the reset switch M_{RST} from the first power rail VDD_{RESET} is substantially the same during two sensing operations of the CDS mechanism. Accordingly, the operating voltage V_{V00}(T1) and the operating voltage V_{V00}(T2) may be regarded as the same, and the pure change component ΔV_{sig} may be obtained through the CDS mechanism.

In more detail, although the VDD_{Reset} in FIG. 3 slightly drops at the time point t0 and the time point t3, since the RC effect of the reset path is limited, the VDD_{Reset} can quickly return to the original voltage level. Therefore, at the time points (time points t2 and t4) for performing the two sensing operations of a pixel read-out cycle, the operating voltage V_{V00}(T1) and the operating voltage V_{V00}(T2) are almost the same, thereby obtaining the pure change component ΔV_{sig} via the CDS mechanism.

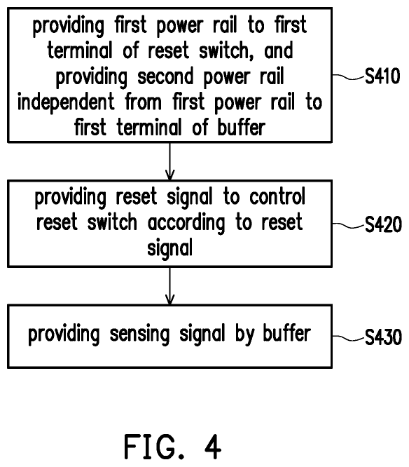

FIG. 4 is a flowchart of an optical sensing method according to an embodiment of the disclosure. Please refer to FIG. 1 and FIG. 4 at the same time. The optical sensing method is applicable (but not limitedly) to the optical sensing device 100 shown in FIG. 1, wherein the optical sensing device 100 includes a plurality of optical sensing elements (such as the optical sensing element P00) arranged in the optical sensing element array 110. Each optical sensing element includes the photo diode PD, the reset switch M_{RST} coupled to the photo diode PD, and the buffer M_{SF} coupled to the reset switch M_{RST} and the photo diode PD. According to design requirements, various structures of optical sensing elements may be implemented and are not limited in the disclosure. Step S410 is to provide the first power rail (that is, the power rail 130 shown in FIG. 1) to the first terminal of the reset switch M_{RST}, and provide the second power rail (that is, the power rail 120 shown in FIG. 1) to the first terminal of the buffer M_{SF}, wherein the second power rail is independent from the first power rail. Step S420 is to provide the reset signal to control the reset switch M_{RST} according to the reset signal. Step S430 is to provide the sensing signal by the buffer. More details of each feature can be analogized from the above embodiments and omitted here for brevity.

In summary, the optical sensing device of the embodiments have two power rails to respectively provide operating voltages of different sources for the reset operation and the sensing operation of the optical sensing element. Since the reset operation is not affected by the sensing operation, the reset voltage (reset to the current operating voltage) of the same optical sensing element at different times may be regarded as the same. Therefore, the signal difference component of the optical sensing element obtained through the CDS mechanism can be relatively pure. Through the optical sensing device and the optical sensing method of the disclosure, the sensing accuracy of optical sensing can be improved.

Lastly, it should be mentioned that the above embodiments are configured to explain the technical solution of the disclosure and are not intended to limit the same. Please refer to the embodiments for detailed explanation of the disclosure. It will be apparent to persons skilled in the art that modifications can be made to the technical solution disclosed by the embodiments or equivalent replacements of some or all technical features can be made. However, the modifications or replacements do not make the essence of the corresponding technical solution to depart from the scope according to the embodiments of the disclosure.

1. An optical sensing device, comprising:
a first power rail;
a second power rail separate or independent from the first power rail; and
a plurality of optical sensing elements, arranged in an optical sensing element array, wherein each of the plurality of optical sensing elements comprises:
a photo diode;
a reset switch, having a control terminal configured to receive a reset signal, a first terminal of the reset switch being coupled to the first power rail, and a second terminal of the reset switch being directly connected to the photo diode; and
a buffer, a first terminal of the buffer being coupled to the second power rail, a second terminal of the buffer being coupled to the second terminal of the reset switch and the photo diode, and a third terminal of the buffer configured to provide a sensing signal.

2. The optical sensing device according to claim 1, wherein the first power rail is coupled to a first power supply and the second power rail is coupled to a second power supply different from the first power supply.

3. The optical sensing device according to claim 1, wherein a first load current flowing through the first power rail is independent from a second load current flowing through the second power rail.

4. The optical sensing device according to claim 1, wherein the first power rail has a first voltage level and the second power rail has a second voltage level same as the first voltage level.

5. The optical sensing device according to claim 1, wherein the first power rail has a first voltage level and the second power rail has a second voltage level different from the first voltage level.

6. The optical sensing device according to claim 1, wherein the buffer comprises:
a source follower, a first terminal of the source follower being coupled to the second power rail, a second terminal of the source follower being coupled to the second terminal of the reset switch, and a third terminal of the source follower providing the sensing signal.

7. The optical sensing device according to claim 6, wherein the buffer further comprises:
a selection switch, controlled by a selection signal, and a first terminal of the selection switch being coupled to the third terminal of the source follower to provide the sensing signal from a second terminal of the selection switch.

8. The optical sensing device according to claim 1, wherein a first terminal of the photo diode is coupled to the second terminal of the reset switch and a second terminal of the photo diode is coupled to a reference voltage.

9. The optical sensing device according to claim 1, wherein the first power rail is located at a first side of the optical sensing element array and the second power rail is located at the first side of the optical sensing element array.

10. The optical sensing device according to claim 1, wherein the first power rail is located at a first side of the optical sensing element array and the second power rail is located at a second side opposite to the first side of the optical sensing element array.

11. The optical sensing device according to claim 1, further comprising a reading out circuit configured to reading the sensing signal according to a correlated double sampling (CDS) mechanism.

12. The optical sensing device according to claim 11, wherein a voltage level received by the reset switch from the first power rail is substantially the same during two sensing operations of a pixel read-out cycle of the CDS mechanism.

13. An optical sensing method, adapted to an optical sensing device, wherein the optical sensing device comprises a plurality of optical sensing elements arranged in an optical sensing element array, each of the plurality of optical sensing elements comprises a photo diode, a reset switch coupled to the photo diode, and a buffer coupled to the reset switch and the photo diode, the optical sensing method comprising:
providing a first power rail to a first terminal of the reset switch, wherein a second terminal of the reset switch is directly connected to the photo diode;
providing a second power rail independent from the first power rail to a first terminal of the buffer;
providing a reset signal to control the reset switch according to the reset signal; and
providing a sensing signal by the buffer.

14. The optical sensing method according to claim 13, wherein the first power rail is coupled to a first power supply and the second power rail is coupled to a second power supply different from the first power supply.

15. The optical sensing method according to claim 13, wherein a first load current flowing through the first power rail is independent from a second load current flowing through the second power rail.

16. The optical sensing method according to claim 13, wherein the first power rail has a first voltage level and the second power rail has a second voltage level same as the first voltage level.

17. The optical sensing method according to claim 13, wherein the first power rail has a first voltage level and the second power rail has a second voltage level different from the first voltage level.

18. The optical sensing method according to claim 13, wherein the buffer comprises a source follower, the optical sensing method further comprising:
providing the sensing signal by the source follower, wherein a first terminal of the source follower is coupled to the second power rail, a second terminal of the source follower is coupled to the second terminal of the reset switch, and a third terminal of the source follower provides the sensing signal.

19. The optical sensing method according to claim 18, wherein the buffer further comprises a selection switch, the optical sensing method further comprising:
turning on by the selection switch according to the selection signal to select a corresponding optical sensing element as a selected optical sensing element, wherein a first terminal of the selection switch is coupled to the third terminal of the source follower to provide the sensing signal from a second terminal of the selection switch.

20. The optical sensing method according to claim 13, wherein a first terminal of the photo diode is coupled to the second terminal of the reset switch and a second terminal of the photo diode is coupled to a reference voltage.

21. The optical sensing device according to claim 1, wherein
the plurality of optical sensing elements is configured to be reset respectively according to a reset voltage in each of two sensing operations during a pixel read-out cycle,
wherein the reset voltage is independent or separate from a voltage provided by the second power rail such that a voltage level of the reset voltage is substantially the same during the two sensing operations of the pixel read-out cycle.
